(19) United States
(12) Patent Application Publication
(10) Pub. No.: US 2026/0178499 A1
(43) Pub. Date: Jun. 25, 2026

(54) Selective Insertion of Prefetched Data and Instructions

(71) Applicant: Advanced Micro Devices, Inc., Santa Clara, CA (US)

(72) Inventors: Uday Kumar Reddy Vengalam, Hamden, CT (US); John Kalamatianos, Arlington, MA (US)

(73) Assignee: Advanced Micro Devices, Inc., Santa Clara, CA (US)

(21) Appl. No.: 18/990,532

(22) Filed: Dec. 20, 2024

(51) Int. Cl. G06F 12/0862; G06F 12/0811; G06F 12/0875

(52) U.S. Cl. CPC G06F 12/0862; G06F 12/0811; G06F 12/0875; G06F 2212/452

(57) ABSTRACT

Systems and techniques for low-power prefetching are described. In one example, a processor includes a cache system having a hierarchy of one or more cache levels and a prefetcher associated with a cache level of the cache system. The prefetcher determines a memory level from which data or instructions associated with a prefetch request is retrieved. In response to the data or instructions being retrieved from a level three cache, a lower cache level, or system memory, the prefetcher stores the data or instructions associated with the prefetch request in a level two cache. The described techniques reduce cache pollution in the level one cache without introducing additional storage overhead.

### BACKGROUND

Memory systems are slower than processors, creating a speed gap that processors address using multiple levels of caches. Caches store frequently accessed instructions and data for rapid retrieval. One way to address this issue is by employing prefetchers to anticipate the future control flow of a workload and prefetch it into the level one cache before it is requested, helping to mitigate the performance degradation from cache misses or longer retrieval times. However, if the prefetched data or instructions are not used by the application before being evicted from the caches, then cache pollution occurs in the level one cache, and other data used by the processors is not stored in the level one cache.

### BRIEF DESCRIPTION OF THE DRAWINGS

FIG. 1 depicts a block diagram of a processing system configured to execute one or more applications in accordance with one or more implementations.

FIG. 2 is a block diagram of a non-limiting example system to implement low-power prefetching.

FIG. 3 depicts an example procedure for assigning a cache level to prefetched data or instructions in accordance with one or more implementations.

FIG. 4 depicts an example procedure for issuing prefetch requests based on the timing of prefetch requests in accordance with one or more implementations.

FIG. 5 depicts an example procedure for checking cache levels in response to a prefetch request in accordance with one or more implementations.

### DETAILED DESCRIPTION

### Overview

An example system includes a processor or system on a chip (SoC) with one or more processor cores communicatively coupled to a memory system with volatile and non-volatile memory. The processor includes a cache system with multiple cache levels. For example, the cache system includes level one caches and level two caches that are private to respective cores of the processor, and a last level cache that is shared among the multiple cores of the processor. The processor further includes a data prefetcher and/or an instruction prefetcher associated with one or each cache level. Broadly, the prefetcher is configured to prefetch data or instructions that are predicted to be accessed by a workload from a slower memory source in terms of memory access speed (e.g., the level two cache, the last level cache, the volatile memory, or the non-volatile memory) into the level one cache.

To prevent cache pollution at higher cache levels (e.g., at the level one or level two caches), some conventional techniques use a prefetch buffer. Prefetched data (e.g., saved data or instructions) is temporarily stored in the prefetch buffer and transferred to the level one cache (or another cache level) once an execution unit of the processor requests the data. If the execution unit does not request the prefetched data, the prefetched data is not transferred to the cache. In this way, this conventional technique reduces cache pollution in an associated cache level. However, a prefetch buffer is generally utilized for each non-shared cache of each processor (e.g., the level one and level two caches), greatly increasing the storage overhead in a SoC and the power consumption associated with unused prefetch requests.

In contrast, this document describes systems and techniques for selective insertion of prefetched data and instructions into a particular cache level. In particular, the systems and techniques utilize hardware-based mechanisms to determine a memory level from which data or instructions associated with a prefetch request are retrieved. In response to the data or instructions being retrieved from a level three cache (or a lower cache level in a cache hierarchy) or system memory, the prefetcher stores the data or instructions associated with the prefetch request in a level two cache. If the data or instructions are retrieved from the level two cache, the prefetcher stores the data or instructions in the level one cache (e.g., the level one data cache or level one instruction cache, respectively) or the micro-op cache. The described techniques take advantage of the fact that data or instructions that reside in the level two cache (e.g., via prior prefetching activity or via level one eviction) have a shorter reuse distance than code lines that have been evicted out to the level three cache or system memory. Accordingly, the described techniques reduce cache pollution in the level one cache without introducing additional storage overhead.

In some aspects, the techniques described herein relate to a processor that includes prefetching circuitry associated with a cache level of a hierarchy of one or more cache levels, the prefetching circuitry configured to determine a memory level from which data associated with a prefetch request is retrieved and store the data associated with the prefetch request in a level two cache in response to the memory level being a level three cache, a lower cache level in the hierarchy of one or more cache levels, or system memory.

In some aspects, the techniques described herein relate to a processor, wherein the prefetching circuitry is further configured to transfer the data from the level two cache to a level one cache in response to the processor requesting the data associated with the prefetch request.

In some aspects, the techniques described herein relate to a processor, wherein the prefetching circuitry is further configured to store the data associated with the prefetch request in a level one cache in response to the memory level being the level two cache.

In some aspects, the techniques described herein relate to a processor, wherein the prefetching circuitry is further configured to store the data associated with the prefetch request in a micro-op cache in response to the memory level being a level one cache or the level two cache.

In some aspects, the techniques described herein relate to a processor, wherein the data associated with the prefetch request is one or more instructions for execution by the processor.

In some aspects, the techniques described herein relate to a processor, wherein the data associated with the prefetch request is one or more constants or variables for the processor to perform operations on.

In some aspects, the techniques described herein relate to a processor, wherein the prefetching circuitry is further configured to add a first time stamp to a prefetcher table entry corresponding to when a first prefetch request is generated from the prefetcher table entry, in response to a subsequent access by the processor to the prefetcher table entry generating a second prefetch request from the prefetcher table entry, compare a second time stamp corresponding to the second prefetch request to the first time stamp, and in response to a difference between the second time stamp and the first time stamp being less than a threshold, not issuing the second prefetch request to the hierarchy of one or more cache levels.

In some aspects, the techniques described herein relate to a processor, wherein the prefetching circuitry is further configured to, in response to the difference between the second time stamp and the first time stamp being greater than or equal to the threshold, issuing the second prefetch request to the hierarchy of one or more cache levels.

In some aspects, the techniques described herein relate to a processor, wherein the prefetching circuitry is further configured to add a fetch physical address associated with the prefetch request to a prefetcher table, generate a hash of a page number associated with the fetch physical address, the fetch physical address, a cache line tag, and a cache line index associated with the fetch physical address; determine, based on the hash, a probability that the data associated with the prefetch request is located in a level one cache of the hierarchy of one or more cache levels, and in response to the probability being less than a threshold, determine whether the data associated with the prefetch request is located in the level two cache without checking the level one cache.

In some aspects, the techniques described herein relate to a processor, wherein the prefetching circuitry is further configured to, in response to the probability being greater than a threshold, determine whether the data associated with the prefetch request is located in the level one cache.

In some aspects, the techniques described herein relate to a system that includes a processor including a cache system with one or more cache levels that include prefetching circuitry, the processor configured to execute one or more workloads and the prefetching circuitry configured to prefetch data associated with a prefetch request into a level two cache of the one or more cache levels in response to the data being retrieved from a lower cache level than the level two cache or system memory, and upon the processor referencing the data for execution of the one or more workloads, transfer the data associated with the prefetch request into a level one cache of the one or more cache levels.

In some aspects, the techniques described herein relate to a system, wherein the prefetching circuitry is further configured to store the data associated with the prefetch request in the level one cache in response to the data being retrieved from the level two cache.

In some aspects, the techniques described herein relate to a system, wherein the prefetching circuitry is further configured to store the data associated with the prefetch request in a micro-op cache in response to the data being retrieved from the level two cache.

In some aspects, the techniques described herein relate to a system, wherein the data associated with the prefetch request is one or more instructions for execution by the processor.

In some aspects, the techniques described herein relate to a system, wherein the data associated with the prefetch request is one or more constants or variables for the processor to perform operations on.

In some aspects, the techniques described herein relate to a system, wherein the prefetching circuitry is further configured to add a first time stamp to a prefetcher table entry corresponding to when a first prefetch request is generated from the prefetcher table entry, in response to a subsequent access by the processor to the prefetcher table entry generating a second prefetch request from the prefetcher table entry, compare a second time stamp corresponding to the second prefetch request to the first time stamp, and in response to a difference between the second time stamp and the first time stamp being less than a threshold, not issuing the second prefetch request to the hierarchy of one or more cache levels.

In some aspects, the techniques described herein relate to a system, wherein the prefetching circuitry is further configured to, in response to the difference between the second time stamp and the first time stamp being greater than or equal to the threshold, issue the second prefetch request to the one or more cache levels.

In some aspects, the techniques described herein relate to a system, wherein the prefetching circuitry is further configured to add a fetch physical address associated with the prefetch request to a prefetcher table, generate a hash of a page number associated with the fetch physical address, the fetch physical address, a cache line tag, and a cache line index associated with the fetch physical address; determine, based on the hash, a probability that the data associated with the prefetch request is located in a level one cache of the one or more cache levels, and in response to the probability being less than a threshold, determine whether the data associated with the prefetch request is located in the level two cache without checking the level one cache.

In some aspects, the techniques described herein relate to a system, wherein the prefetching circuitry is further configured to, in response to the probability being greater than a threshold, determine whether the data associated with the prefetch request is located in the level one cache.

In some aspects, the techniques described herein relate to a method that includes determining a memory level from which data associated with a prefetch request is retrieved and storing the data associated with the prefetch request in a level two cache in response to the memory level being a level three cache of a hierarchy of one or more cache levels, a lower cache level in the hierarchy of one or more cache levels, or system memory.

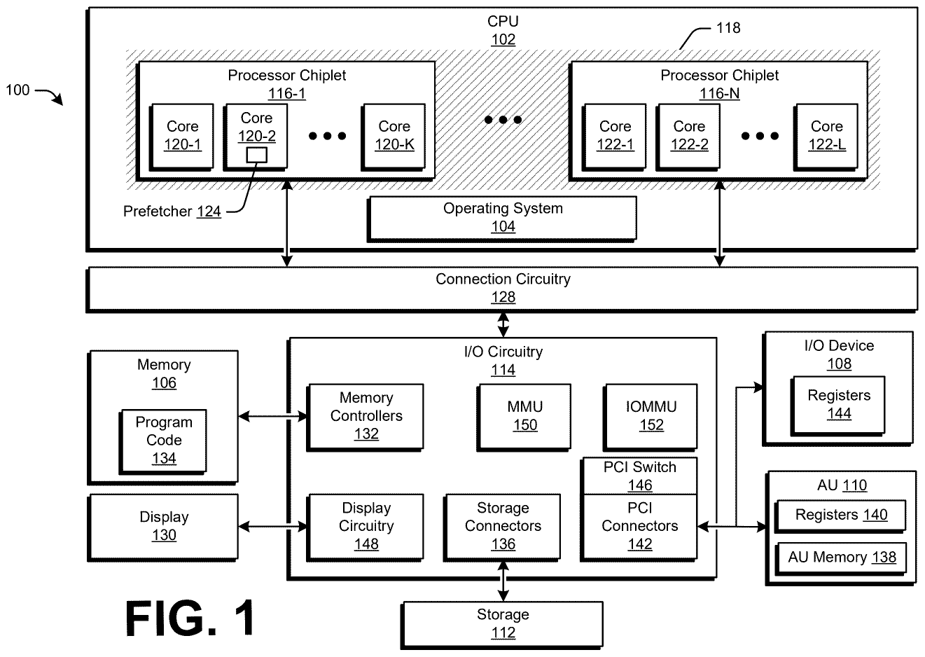

FIG. 1 is a block diagram of a processing system configured to execute one or more applications, in accordance with one or more implementations.

FIG. 1 includes a processing system 100 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 112, I/O circuitry 114) for the execution of tasks for the applications, provide an interface to I/O devices (e.g., I/O device 108) for the applications, or any combination thereof.

The CPU 102 includes one or more processor chiplets 116, which are communicatively coupled together by a data fabric 118 in one or more implementations.

Each of the processor chiplets 116, for example, includes one or more processor cores 120, 122 configured to concurrently execute one or more series of instructions, also referred to herein as “threads,” for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116. Though the example embodiment presented in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

In this example, the prefetcher 124 is depicted in the core 120-2. In variations, however, the prefetcher 124 is included in and/or are implemented by one or more different components of the processing system 100, such as the other processor cores 120, 122, CPU 102, the AU 110, and so forth. In at least one implementation, the prefetcher 124 or portions thereof are included in at least two of the depicted components of the processing system 100 (e.g., each processor core 120, 122).

Additionally, within the processing system 100, the CPU 102 is communicatively coupled to an I/O circuitry 114 by a connection circuitry 128. For example, each processor chiplet 116 of the CPU 102 is communicatively coupled to the I/O circuitry 114 by the connection circuitry 128. The connection circuitry 128 includes, for example, one or more data fabrics, buses, buffers, queues, and the like. The I/O circuitry 114 is configured to facilitate communications between two or more components of the processing system 100 such as between the CPU 102, system memory 106, display 130, universal serial bus (USB) devices, peripheral component interconnect (PCI) devices (e.g., I/O device 108, AU 110), storage 112, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 114 includes one or more memory controllers 132. These memory controllers 132, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, these memory controllers 132 are configured to manage access to the data stored at one or more memory addresses within the system memory 106, such as by CPU 102, the I/O device 108, and/or the AU 110.

When an application is to be executed by processing system 100, the OS 104 running on the CPU 102 is configured to load at least a portion of program code 134 (e.g., an executable file) associated with the application from, for example, a storage 112 into system memory 106. This storage 112, for example, includes a non-volatile storage such as a flash memory, solid-state memory, hard disk, optical disc, or the like configured to store program code 134 for one or more applications.

To facilitate communication between the storage 112 and other components of processing system 100, the I/O circuitry 114 includes one or more storage connectors 136 (e.g., universal serial bus (USB) connectors, serial AT attachment (SATA) connectors, PCI Express (PCIe) connectors) configured to communicatively couple storage 112 to the I/O circuitry 114 such that I/O circuitry 114 is capable of routing signals to and from the storage 112 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 138. This AU memory 138, for example, includes any combination of one or more volatile memories and/or non-volatile memories, examples of which include caches, video RAM (VRAM), or the like. In one or more implementations, these compute units are also configured to execute these threads based on the data stored in one or more physical registers 140 of the AU 110.

To facilitate communication between the AU 110 and one or more other components of processing system 100, the I/O circuitry 114 includes or is otherwise connected to one or more connectors, such as PCI connectors 142 (e.g., PCIe connectors) each including circuitry configured to communicatively couple the AU 110 to the I/O circuitry such that the I/O circuitry 114 is capable of routing signals to and from the AU 110 to one or more other components of the processing system 100. Further, the PCIe connectors 142 are configured to communicatively couple the I/O device 108 to the I/O circuitry 114 such that the I/O circuitry 114 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 144 of the I/O device 108. In one or more implementations, such physical registers 144 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 142, and one or more other components of the processing system 100, the I/O circuitry 114 includes PCI switch 146. The PCI switch 146, for example, includes circuitry configured to route packets to and from the components of the processing system 100 connected to the PCI connectors 142 as well as to the other components of the processing system 100. As an example, based on address data indicated in a packet received from a first component (e.g., CPU 102), the PCI switch 146 routes the packet to a corresponding component (e.g., AU 110) connected to the PCI connectors 142.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 112, displays the scene on the display 130, or both. The display 130, for example, includes a cathode-ray tube (CRT) display, liquid crystal display (LCD), light emitting diode (LED) display, organic light emitting diode (OLED) display, or any combination thereof. To enable the processing system 100 to display a scene on the display 130, the I/O circuitry 114 includes display circuitry 148. The display circuitry 148, for example, includes high-definition multimedia interface (HDMI) connectors, DisplayPort connectors, digital visual interface (DVI) connectors, USB connectors, and the like, each including circuitry configured to communicatively couple the display 130 to the I/O circuitry 114. Additionally or alternatively, the display circuitry 148 includes circuitry configured to manage the display of one or more scenes on the display 130 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 114 includes memory management unit (MMU) 146 and input-output memory management unit (IOMMU) 148. The MMU 150 includes, for example, circuitry configured to manage memory requests, such as from the CPU 102 to the system memory 106. For example, the MMU 150 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 150 is configured to translate the virtual address indicated in the memory request to a physical address in the system memory 106 and to fulfill the request. The IOMMU 152 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 144 of the I/O device 108, the registers 140 of the AU 110, and/or the AU memory 138, the CPU 102 issues one or more MMIO requests. Such MMIO requests each request access to read, write, fetch, or pre-fetch data residing at one or more virtual addresses (e.g., guest virtual addresses) which each represent at least a portion of the registers 144 of the I/O device 108, the registers 140 of the AU 110, or the AU memory 138, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 152 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The 100 is configurable in a variety of ways with different combinations of components in accordance with the described techniques.

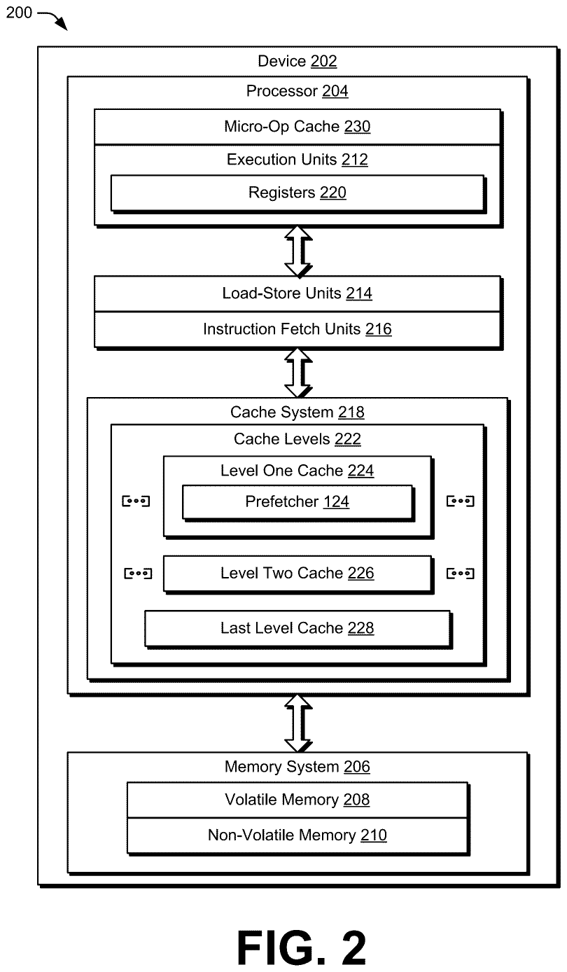

FIG. 2 is a block diagram of a non-limiting example system 200 to implement low-power prefetching. The system 200 includes a device 202 having a processor 204 and a memory system 206 having volatile memory 208 and non-volatile memory 210. The device 202 is configurable in a variety of ways. Examples of the device 202 include, by way of example and not limitation, computing devices, servers, mobile devices (e.g., wearables, mobile phones, tablets, laptops), processors (e.g., graphics processing units, central processing units, and accelerators), digital signal processors, disk array controllers, hard disk drive host adapters, memory cards, solid-state drives, wireless communications hardware connections, Ethernet hardware connections, switches, bridges, network interface controllers, and other apparatus configurations. It is to be appreciated that in various implementations, the device 202 is configured as any one or more of those devices listed just above and/or a variety of other devices without departing from the spirit or scope of the described techniques.

In accordance with the described techniques, the processor 204 and the memory system 206 are coupled to one another via one or more wired and/or wireless connections. Example wired connections include, but are not limited to, buses (e.g., a data bus), interconnects, traces, and planes. The processor 204 is an electronic circuit that reads, translates, and executes workloads of a program, e.g., an application, operating system, virtual machine, container, and so on. Examples of the processor 204 include, but are not limited to including, central processing units (CPUs), graphics processing units (GPUs), Field Programmable Gate Arrays (FPGAs), Application Specific Integrated Circuits (ASICs), digital signal processors (DSPs), and accelerator devices.

The volatile memory 208 and the non-volatile memory 210 are devices and/or systems used to store information, such as for use by the processor 204. By way of example, the processor 204 includes a memory module (e.g., a Transflash memory module, a single in-line memory module (SIMM), or a dual in-line memory module (DIMM)), and the memory module is a circuit board (e.g., a printed circuit board) on which the volatile memory 208 and the non-volatile memory 210 are mounted. Further, the volatile memory 208 and the non-volatile memory 210 correspond to semiconductor memory, where data is stored within memory cells on one or more integrated circuits.

Broadly, the volatile memory 208 retains data as long as the device 202 is connected to power, and the data is accessible relatively faster than the non-volatile memory 210. Examples of volatile memory 208 include random-access memory (RAM), dynamic random-access memory (DRAM), synchronous dynamic random-access memory (SDRAM), and static random-access memory (SRAM).

The non-volatile memory 210 retains data even after the device 202 is disconnected from power, but is accessible relatively slower than the volatile memory 208. Examples of non-volatile memory include solid state disks (SSD), flash memory, read-only memory (ROM), programmable read-only memory (PROM), erasable programmable read-only memory (EPROM), and electronically erasable programmable read-only memory (EEPROM).

As shown, the processor 204 includes one or more execution units 212, one or more load-store units 214, one or more instruction fetch units 216, and a cache system 218 coupled to one another via one or more wired and/or wireless connections. An execution unit 212 is representative of functionality implemented in hardware (e.g., electronic circuitry) of the processor 204 to perform specific types of workloads, such as arithmetic and logic operations. Further, a load-store unit 214 is representative of functionality implemented in the hardware of the processor 204 to perform load and store operations of data as part of a workload. The execution units 212, the load-store units 214, and the instruction fetch units 216 perform respective operations based on requests received through the execution of software programs, e.g., applications, operating systems, virtual machines, containers, and so on. By way of example, requests are generated and forwarded to the execution units 212, the load-store units 214, and/or the instruction fetch units 216 by a control unit (not depicted) of the processor 204.

Load requests instruct the load-store units 214 to load data from the cache system 218, the volatile memory 208, and/or the non-volatile memory 210 into registers 220 of the execution units 212. Similarly, fetch requests direct the instruction fetch units 216 to load instructions from the cache system 218, the volatile memory 208, and/or the non-volatile memory 210 into the front end part of the pipeline of the processor 204. Once data is loaded into registers 220, instructions become ready for execution by execution units 212 to perform corresponding operations according to instruction opcodes.

As illustrated, the cache system 218 includes multiple cache levels 222, including a level one cache (L1 cache) 224, which includes a level one data cache and a level one instruction cache (L1 IC), a level two cache (L2 cache) 226, and a last level cache (L3 cache) 228. By way of example, processor 204 is a multi-core processor, and each respective core includes the L1 cache 224 and L2 cache 226 that are exclusively used by a respective core. Furthermore, the processor 204 includes the L3 cache 228 shared among the multiple cores of the processor 204. The cache system 218 often also includes a micro-op cache (UOP cache) 230 that stores decoded instructions in a format ready for execution.

The cache system 218 corresponds to semiconductor memory where data and instructions are stored within memory cells on one or more integrated circuits. The higher cache levels are accessible (e.g., for loading and/or storing data instructions and/or data with the L1 cache 224 and L2 cache 226) relatively faster than the lower cache levels (e.g., L3 cache 228). Lower cache levels in the hierarchy of cache levels generally have greater memory capacity than higher cache levels. In other implementations, the cache system 218 includes differing numbers of cache levels and different hierarchical structures without departing from the spirit or scope of the described techniques.

The cache system 218 is accessible (e.g., for loading and/or storing instructions and data) relatively faster than the memory system 206. The various memory sources of processor 204 are ordered from fastest access speed to slowest access speed in the following order: (1) L1 cache 224, (2) L2 cache 226, (3) L3 cache 228, (4) the volatile memory 208, and (5) the non-volatile memory 210. As a result, a load-store unit 214 executes a load request that includes a memory address by progressively checking the memory sources for the identified data in the aforementioned order. Similarly, an instruction fetch unit 216 executes a fetch request that includes a memory address of the requested instruction by progressively checking the memory sources for the identified instruction in the aforementioned order. For example, if the instruction is present in a memory source, the instruction fetch unit 216 fetches the instruction from that memory source into the L1 IC, the processor 204 decodes the instruction and sends it to execution unit 212, where the loaded instruction waits for its operands from the load-store units 214 before being executed by execution units 212. If the instruction is not in a memory source, the instruction fetch unit 216 checks whether the instruction is present in the next memory source.

As illustrated in FIG. 1, the L1 cache 224 includes a prefetcher 124 (e.g., prefetching circuitry), which is representative of functionality implemented in the hardware of the processor 204 to prefetch data or instructions that are predicted to be used (e.g., in the near future) by a workload of a runtime program. For example, the prefetcher 124 is an electronic circuit that monitors the fetch activity of the workload and predicts which data or instructions are likely to be accessed. The prefetcher 124 then issues a prefetch request to fetch data or instructions of the predicted memory address from a slower memory source in terms of access speed (e.g., L2 cache 226, L3 cache 228, the volatile memory 208, or the non-volatile memory 210) into the L1 cache 224. Examples of the prefetcher 124 include but are not limited to dedicated instruction prefetchers that use dedicated tables to track prior instruction fetch activity or branch prediction-directed prefetchers.

Although not depicted, it is appreciated that the L2 cache 226 and L3 cache 228 each include a prefetcher 124 with similar functionality. Additionally or alternatively, the prefetcher 124 prefetches data or instructions from the volatile memory 208 and/or the non-volatile memory 210 into each of the various cache levels 222 of the cache system 218. Regardless of configuration, the prefetch requests issued by the prefetcher 124 improve overall computer performance by accurately prefetching data or instructions and by maintaining metadata for data or instructions based on a relative cost to retrieve such data or instructions from the cache system 218 and/or the memory system 206.

Similarly, it is appreciated that the L1 cache 224, L2 cache 226, and L3 cache 228 each include a data cache and an instruction cache with the prefetcher 124 with similar functionality. Additionally or alternatively, the prefetcher 124 associated with L1 cache 224 prefetches data or instructions from the volatile memory 208 and/or the non-volatile memory 210 into each of the various cache levels 222 of the cache system 218. Regardless of configuration, the prefetch requests issued by the prefetcher 124 improve overall computer performance by accurately prefetching data or instructions and maintaining metadata for data or instructions based on based on the memory source to retrieve such data or instructions in various implementation scenarios.

In some scenarios, prefetchers prefetch instructions or data that are not accessed immediately or at all by the respective processor, resulting in cache pollution. Cache pollution generally occurs when an associated workload does not access the data entering the cache before it gets evicted. For example, unnecessary prefetches occur when a prefetcher predicts future data or instructions to be accessed by a workload based on a detected stride pattern or branch prediction, but the workload exits or completes the pattern (e.g., an arithmetic loop) before needing the prefetched data or instructions. In such scenarios, the cache could experience frequent evictions of needed data or instructions, which causes system performance degradation. If repeated for multiple routines within or across workloads, the unnecessary prefetching generates significant traffic in the communication channels between the cache and the lower levels of memory, thereby delaying other access requests. In addition, the unnecessary prefetched data or instructions occupy capacity in the cache.

Some conventional techniques integrate prefetch buffers to store the prefetched lines (e.g., data or instructions) temporarily. The prefetched lines are transferred from the prefetch buffer to the corresponding cache when the workload requests these lines. Otherwise, the prefetched lines are not transferred into the corresponding cache. Prefetch buffers reduce cache pollution at a particular cache level, but increase the storage overhead associated with the cache system.

In contrast, the described prefetcher 124 selectively inserts the prefetched lines into the L1 cache 224 to reduce cache pollution at this cache level without increasing the storage size of the cache system 218. Prefetched lines retrieved from the L2 cache 226 are inserted by the prefetcher 124 into the L1 cache 224. Otherwise, prefetched lines retrieved from other memory sources (e.g., the L3 cache 228, volatile memory 208, and non-volatile memory 210) are inserted into the L2 cache 226. These lines placed into the L2 cache 226 are promoted to the L1 cache 224 if a workload references or utilizes the prefetched lines. By selectively inserting prefetched lines based on their memory source, the described techniques reduce L1 cache pollution without requiring additional storage. It is appreciated that the same techniques are utilizable by a prefetcher 124 at the UOP cache 230, L2 cache 226, and L3 cache 228.

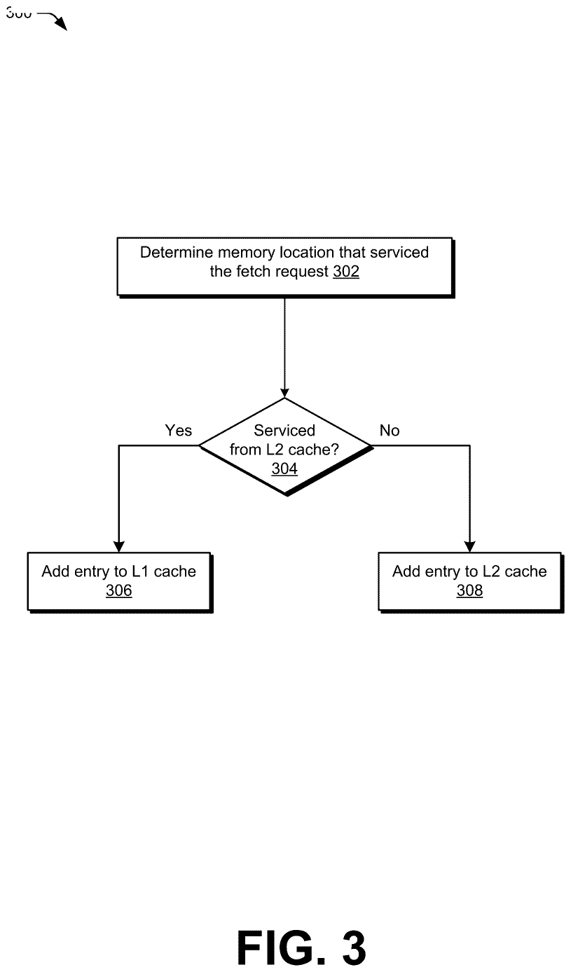

FIG. 3 depicts an example procedure 300 for assigning a cache level to prefetched data or instructions in accordance with one or more implementations.

Upon fetching of data or instructions by the prefetcher 124 or another component in the device 202, the prefetcher 124 or another component therein determines a memory location that serviced the corresponding fetch request (block 302). The memory location determination includes a corresponding memory level. The prefetcher 124 then determines whether the data was serviced from the L2 cache 226 (block 304). In response to the data being retrieved from the L2 cache 226 (e.g., a “yes” determination at block 304), the prefetcher 124 adds the data or instructions to the L1 cache 224 (e.g., instructions are added to the L1 IC and data is added to the L1 data cache) (block 306). In response to the data not being retrieved from the L2 cache 226 but from a lower memory level (e.g., a “no” determination at block 304), the prefetcher 124 adds the data or instructions to the L2 cache 226 (block 308). In other words, the cache assigned to each cache line worth of data or instructions is based on the memory level 304 that serviced the request for that cache line when those data or instructions were fetched. In response to the data being retrieved from the L1 cache 224 or UOP cache 230, the prefetcher 124 does not move the data or instructions.

In the three-level cache hierarchy illustrated in FIG. 2, data or instructions are prefetched from one of the following memory sources: L1 cache 224, UOP cache 230, L2 cache 226, last level cache 228, volatile memory 208 (e.g., DRAM attached to the device 202), remote memory (e.g., DRAM attached via CXL). Because the fetch latency from the L1 cache 224 and the UOP cache 230 are similar, the prefetcher 124 assigns cache lines to either of these caches if the cache lines were retrieved from the L2 cache 226. Cache lines from the other lower hierarchy levels are assigned to the L2 cache 226.

The prefetcher 124 may link multiple prefetcher table entries via pointers. Each prefetcher table entry may be uniquely associated with a set of addresses. The pointers, linking multiple entries together, are set if the addresses associated with the prefetcher table entries are accessed by the application in the same temporal order. When a prefetcher table entry is accessed by processor 204, the prefetcher 124 may generate requests from both the current entry and from the entry or entries linked to the current entry via valid pointer(s). Prefetch requests may continue to be generated by traversing the valid pointers linking prefetcher table entries. Prefetch request generation stops when a table entry with an invalid pointer is found. If later on, processor 204 accesses one of the previously accessed prefetcher table entries it can generate the same prefetch requests.

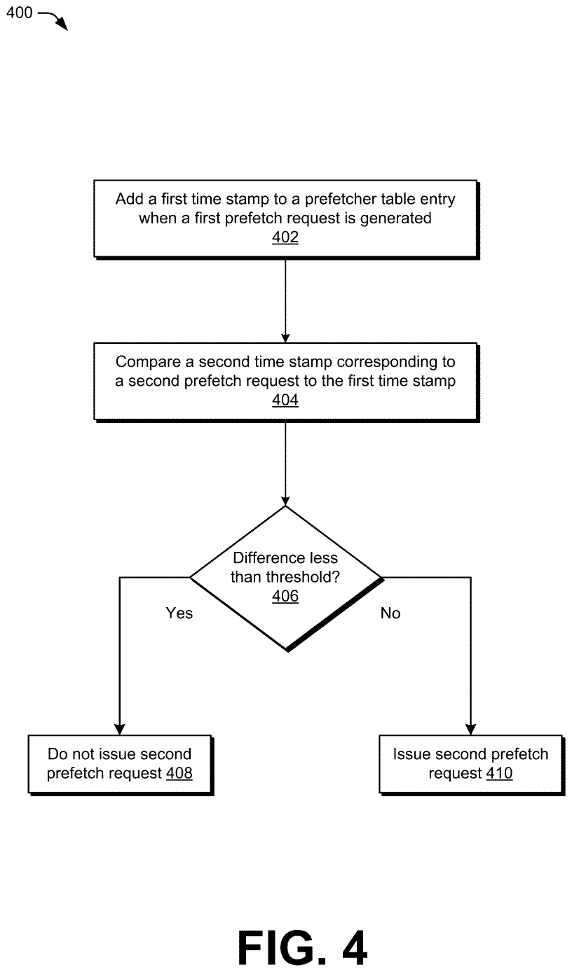

FIG. 4 depicts an example procedure 400 for issuing prefetch requests based on the timing of prefetch requests in accordance with one or more implementations. In order to avoid issuing redundant prefetch requests, the prefetcher uses a time-stamp-based technique to filter prefetch requests. Each entry in a prefetcher table is assigned a time stamp when the entry is used to generate a prefetch request. At 402, a first time stamp is added to a prefetcher table when the table entry is used to generate a first prefetch request. A second time stamp is added to the prefetcher table when the table entry is reused to generate a second prefetch request. At 404, upon revisiting the same entry in the prefetcher table, the prefetcher 124 determines the difference between the first time and the second time stamps. At 406, the prefetcher 124 determines whether the difference between the time stamps is less than a threshold.

The prefetcher 124 generates prefetch requests from that entry only if the time difference between the recorded time stamp and the current cycle exceeds a programmable threshold to avoid generating redundant prefetch requests if the control flow of the processor 204 revisits the same code region within a predefined time interval (e.g., when the prefetcher 124 generates prefetch requests from multiple entries at a time via pointers that link multiple entries together). At 408, in response to the time stamp difference being less than the threshold (e.g., a “yes” determination at step 406), the prefetcher 124 does not issue the second prefetch request. At 410, in response to the time stamp difference being greater than the threshold (e.g., a “no” determination at step 406), the prefetcher 124 issues the second prefetch request.

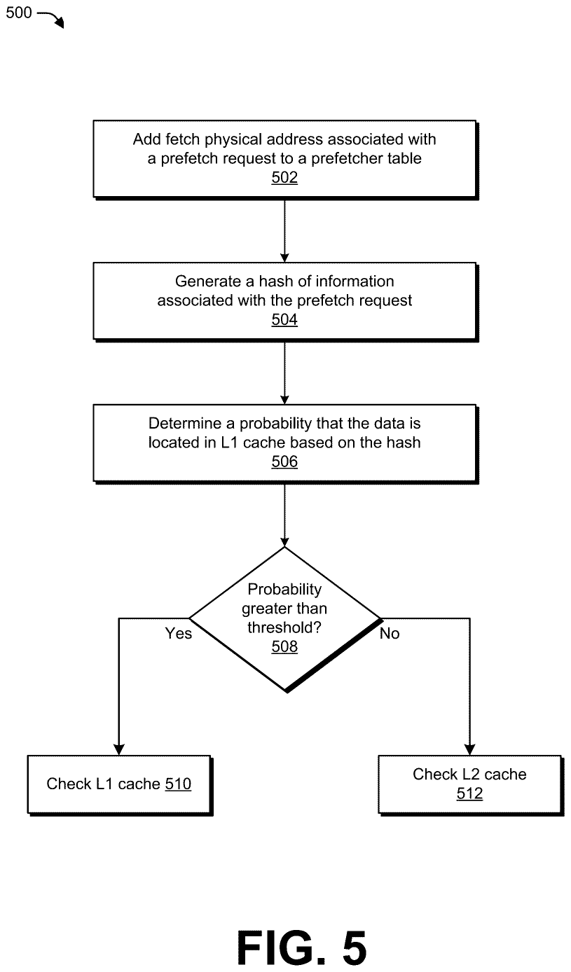

FIG. 5 depicts an example procedure 500 for checking cache levels in response to a prefetch request in accordance with one or more implementations.

Conventional prefetcher requests targeting a cache initially query that cache level, resorting to lower memory levels in response to a cache miss. While this alleviates bandwidth contention at lower memory levels, this conventional approach increases power consumption. In contrast, the described techniques use a hashed perceptron-based predictor tailored to predict L1 cache presence in at least one implementation.

At 502, a fetch physical address associated with a prefetch request is added to a prefetcher table. The predictor uses the page number of the physical address, the physical address, the bits of the physical address to be stored as the tag in the L1 cache, and the bits of the physical address to be stored as the L1 cache line index. At 504, the predictor uses a hash function to transform these features into a perceptron-based predictor index or hash. The perceptron-based predictor is trained on updates and evictions from the L1 cache 224 within the regular prefetcher flow and then applied to the prefetch flow.

The prefetcher 124 incorporates the perceptron-based predictor to reduce L1 cache 224 lookups. At 506, in response to converting prefetch request addresses from virtual addresses to physical addresses, the perceptron-based predictor determines a probability that the data associated with the prefetch request is located in the L1 cache based on the hash. In other words, the predictor forecasts L1 cache presence.

At 508, the predictor determines if the probability is greater than a threshold. If the perceptron-based predictor predicts likely L1 cache presence for an address (e.g., more likely than not), an L1 cache lookup is made. In this way, the perceptron-based predictor reduces L1 cache lookups. At 510, in response to determining that the probability is greater than the threshold (e.g., a “yes” determination at step 508), the prefetcher 124 checks the L1 cache for the requested data. At 512, in response to determining that the probability is less than the threshold (e.g., a “no” determination at step 508), the prefetcher 124 bypasses the L1 cache and checks the L2 cache for the requested data.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the device 202, the processor 204, the memory system 206 having the volatile memory 208 and the non-volatile memory 210, the execution units 212, the load-store units 214, the instruction fetch units 216, the cache system 218, and the prefetcher 124) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. A processor, comprising:
prefetching circuitry associated with a cache level of a hierarchy of one or more cache levels, the prefetching circuitry configured to:
determine a memory level from which data associated with a prefetch request is retrieved; and
store the data associated with the prefetch request in a level two cache in response to the memory level being lower than a level three cache in the hierarchy of one or more cache levels or system memory.

2. The processor of claim 1, wherein the prefetching circuitry is further configured to transfer the data from the level two cache to a level one cache in response to the processor requesting the data associated with the prefetch request.

3. The processor of claim 1, wherein the prefetching circuitry is further configured to store other data associated with a subsequent prefetch request in a level one cache or the level two cache in response to the memory level from which the other data is retrieved being the level two cache or the level three cache, respectively, wherein the level one cache and the level two cache being higher levels in the hierarchy.

4. The processor of claim 1, wherein the prefetching circuitry is further configured to store other data associated with a subsequent prefetch request in a micro-op cache in response to the memory level from which the other data is retrieved being a level one cache or the level two cache.

5. The processor of claim 1, wherein the data associated with the prefetch request is one or more instructions for execution by the processor.

6. The processor of claim 1, wherein the data associated with the prefetch request is one or more constants or variables for the processor to perform operations on.

7. The processor of claim 1, wherein the prefetching circuitry is further configured to:
add a first time stamp to a prefetcher table entry corresponding to when a first prefetch request is generated from the prefetcher table entry;
in response to a subsequent access by the processor to the prefetcher table entry generating a second prefetch request from the prefetcher table entry, compare a second time stamp corresponding to the second prefetch request to the first time stamp; and
in response to a difference between the second time stamp and the first time stamp being less than a threshold, not issue the second prefetch request to the hierarchy of one or more cache levels.

8. The processor of claim 7, wherein the prefetching circuitry is further configured to:
in response to the difference between the second time stamp and the first time stamp being greater than or equal to the threshold, issue the second prefetch request to the hierarchy of one or more cache levels.

9. The processor of claim 1, wherein the prefetching circuitry is further configured to:
add a fetch physical address associated with the prefetch request to a prefetcher table;
generate a hash of a page number associated with the fetch physical address, the fetch physical address, a cache line tag, and a cache line index associated with the fetch physical address;
determine, based on the hash, a probability that the data associated with the prefetch request is located in a level one cache of the hierarchy of one or more cache levels; and
in response to the probability being less than a threshold, determine whether the data associated with the prefetch request is located in the level two cache without checking the level one cache.

10. The processor of claim 9, wherein the prefetching circuitry is further configured to:
in response to the probability being greater than a threshold, determine whether the data associated with the prefetch request is located in the level one cache.

11. A system comprising:
a processor including a cache system with one or more cache levels that include prefetching circuitry, the processor configured to execute one or more workloads; and
the prefetching circuitry configured to:
prefetch data associated with a prefetch request into a level two cache of the one or more cache levels in response to the data being retrieved from a lower cache level than a level three cache or system memory; and
upon the processor referencing the data for execution of the one or more workloads, transfer the data associated with the prefetch request into a level one cache of the one or more cache levels.

12. The system of claim 11, wherein the prefetching circuitry is further configured to store other data associated with a subsequent prefetch request in the level one cache or the level two cache in response to the other data being retrieved from the level two cache or the level three cache, respectively.

13. The system of claim 11, wherein the prefetching circuitry is further configured to store other data associated with a subsequent prefetch request in a micro-op cache in response to the other data being retrieved from the level two cache.

14. The system of claim 11, wherein the data associated with the prefetch request is one or more instructions for execution by the processor.

15. The system of claim 11, wherein the data associated with the prefetch request is one or more constants or variables for the processor to perform operations on.

16. The system of claim 11, wherein the prefetching circuitry is further configured to:
add a first time stamp to a prefetcher table entry corresponding to when a first prefetch request is generated from the prefetcher table entry;
in response to a subsequent access by the processor to the prefetcher table entry generating a second prefetch request from the prefetcher table entry, compare a second time stamp corresponding to the second prefetch request to the first time stamp; and
in response to a difference between the second time stamp and the first time stamp being less than a threshold, not issue the second prefetch request to the one or more cache levels.

17. The system of claim 16, wherein the prefetching circuitry is further configured to:
in response to the difference between the second time stamp and the first time stamp being greater than or equal to the threshold, issue the second prefetch request to the one or more cache levels.

18. The system of claim 11, wherein the prefetching circuitry is further configured to:
add a fetch physical address associated with the prefetch request to a prefetcher table;
generate a hash of a page number associated with the fetch physical address, the fetch physical address, a cache line tag, and a cache line index associated with the fetch physical address;
determine, based on the hash, a probability that the data associated with the prefetch request is located in a level one cache of the one or more cache levels; and
in response to the probability being less than a threshold, determine whether the data associated with the prefetch request is located in the level two cache without checking the level one cache.

19. The system of claim 18, wherein the prefetching circuitry is further configured to:
in response to the probability being greater than the threshold, determine whether the data associated with the prefetch request is located in the level one cache.

20. A method comprising:
determining a memory level from which data associated with a prefetch request is retrieved; and
storing the data associated with the prefetch request in a level two cache in response to the memory level being a cache level less than a level three cache of a hierarchy of one or more cache levels or system memory.
